(19) United States
(12) Patent Application Publication
(10) Pub. No.: US 2002/0046487 A1
(43) Pub. Date: Apr. 25, 2002

(54) Treated seed production system & method

(76) Inventors: Graham Claude Windeatt, Narrabri (AU); Jeremy Wilmot Holcombe, Wee Waa (AU)

Correspondence Address: LOWELL ANDERSON, STETINA BRUNDA GARRED & BRUCKER, 75 Enterprise Suite 250, Aliso Viejo, CA, 92656, US

(21) Appl. No.: 09/872,170

(22) Filed: Jun. 1, 2001

(30) Foreign Application Priority Data
Jun. 1, 2000 (AU) PQ7904

(51) Int. Cl. A01B 79/02

(52) U.S. Cl. 47/58.1 SE

(57) ABSTRACT

A method of producing treated seed for cotton planting comprising the steps of, in order:

i. Delinting the seed;

ii. Storing the seed in bags for a predetermined period of time;

iii. Testing a predetermined portion of the seed for suitability for planting;

Only that seed which is tested as suitable for planting is treated with chemicals which render the seed more suitable for planting.

The present invention relates to a treated seed production system and, more particularly, to such a system particularly suited for the production of cotton seed for planting.

### CROSS-REFERENCE TO RELATED APPLICATIONS

The present application is a continuation-in-part of Australian Provisional Patent Application No. PQ7904 entitled TREATED SEED PRODUCTION SYSTEM & METHOD filed Jun. 1, 2000, the entirety of the disclosure of which is expressly incorporated herein by reference.

### BACKGROUND

Currently, where it is desired to provide seed of a suitable quality and suitably treated for planting purposes there is commonly provided a continuous production process which starts with a predetermined bulk quantity of non-delinted, untreated seed. The process then passes that predetermined quantity through a continuous process as illustrated in block diagram form in FIG. 1.

Disadvantages associated with this arrangement include:

1. Relevant testing of seed as to its suitability for use is carried out after the seed has been treated with certain chemicals. In the case of FIG. 1 the chemicals are a pesticide and a fungicide. Any seed which fails the test must be discarded as unfit for any further commercial use. This represents a loss of seed and a loss of the chemicals which have already been applied to the seed.

2. These days the number of seed varieties is growing and there is also a demand for the seeds to be more selectively treated according to their ultimate intended use. The bulk continuous process of FIG. 1 is not readily suited to such a selective system.

3. The bulk continuous process of FIG. 1, being serial in nature, can proceed only as fast as the slowest step in the chain with the result that economies which could be achieved by processing at a higher rate cannot be taken advantage of.

It is an object of the present invention to address or ameliorate one or more of the abovementioned disadvantages.

### BRIEF DESCRIPTION OF INVENTION

Accordingly, in one broad form of the invention there is provided a method of producing treated seed for cotton planting comprising the steps of, in order:

i. Delinting the seed;

ii. Storing the seed in bags for a predetermined period of time;

iii. Testing a predetermined portion of the seed for suitability for planting;

iv. Only that seed which is tested as suitable for planting is treated with chemicals which render the seed more suitable for planting.

Preferably that seed which is discarded as unsuitable is made available for other commercial use.

Preferably said other commercial use is stock feed.

Preferably treatment of seed with chemicals is carried out at a rate higher than the rate at which seed is delinted.

In a further broad form of the invention there is provided a method of intermediate storage of a predetermined quantity of seed comprising storing said predetermined quantity as a plurality of discrete volumes of seed.

Preferably said discrete volume comprises a pallet load of seed.

Preferably said discrete volumes are further subdivided as a plurality of discrete sub-volumes.

Preferably said discrete sub-volume comprises a bag of seeds.

Preferably said bag is comprised of a paper-based material.

In yet a further broad form of the invention there is provided a method of intermediate storage of a quantity of seeds comprising placing said seeds in bags for storage for a predetermined period of time prior to the application of a chemical treatment process to said seeds.

Preferably said chemical treatment process comprises coating said seeds with a chemical.

Preferably said chemical treatment process comprises application of a chemical pesticide to said seed.

Preferably said chemical process comprises the application of a fungicide to said seeds.

Preferably an application of said chemical pesticide or said fungicide is performed by means of spray delivery through a nozzle; said nozzle incorporating self-cleaning means.

Preferably said self-cleaning means comprises a nozzle adapted to deliver a spray of cleaning solution substantially across an orifice of said nozzle.

Preferably said nozzle delivers said cleaning solution substantially at right-angles to the direction at which pesticide/fungicide exits from said orifice.

Preferably said cleaning solution is caused to spray intermittently across said orifice.

Preferably said chemical treatment process processes 20 tonnes or more of seeds per hour.

In yet a further broad form of the invention there is provided a method of preparing seeds for use as cotton planting seed, said method comprising a first pre-testing phase which includes storage of seeds for an indeterminent period in bags followed, after testing, by a post-testing phase which comprises applying a chemical treatment to that seed which has passed said test thereby rendering that portion of said seed which has passed said test more suited for use as cotton planting seed.

Preferably an application of said chemical pesticide or said fungicide is performed by means of spray delivery through a nozzle; said nozzle incorporating self-cleaning means.

Preferably said self-cleaning means comprises a nozzle adapted to deliver a spray of cleaning solution substantially across an orifice of said nozzle.

Preferably said nozzle delivers said cleaning solution substantially at right-angles to the direction at which pesticide/fungicide exits from said orifice.

Preferably said cleaning solution is caused to spray intermittently across said orifice.

In yet a further broad form of the invention there is provided an apparatus for the production of cotton planting seed, said apparatus operating according to the method described above.

In yet a further broad form of the invention there is provided a spray nozzle for a pesticide or fungicide; said nozzle incorporating an orifice adapted to deliver said pesticide or said fungicide in a first exit direction; a cleaning nozzle mounted in a predetermined relationship to said orifice whereby cleaning solution is delivered by said cleaning nozzle in a direction substantially at right-angles to said first exit direction, thereby to clean said orifice.

Preferably said cleaning solution is delivered by said cleaning nozzle as an intermittent spray.

### BRIEF DESCRIPTION OF DRAWINGS

One embodiment of the present invention will now be described with reference to the accompanying drawings wherein:

FIG. 1 is a block diagram of a prior art bulk continuous process for treated seed production;

FIG. 2 is a flow diagram for a process for treated seed production according to a first embodiment of the invention;

FIG. 3 is a view of the step of chemical treatment in a method of intermediate storage of seeds forming part of the process of FIG. 2; and

FIG. 4 is a detailed view of a spray nozzle arrangement suitable for use in the step of chemical treatment forming part of the process of FIG. 2;

FIG. 5 is a detailed cross-section view of one of the spray nozzles of the arrangement of FIG. 4.

### DETAILED DESCRIPTION OF PREFERRED EMBODIMENT

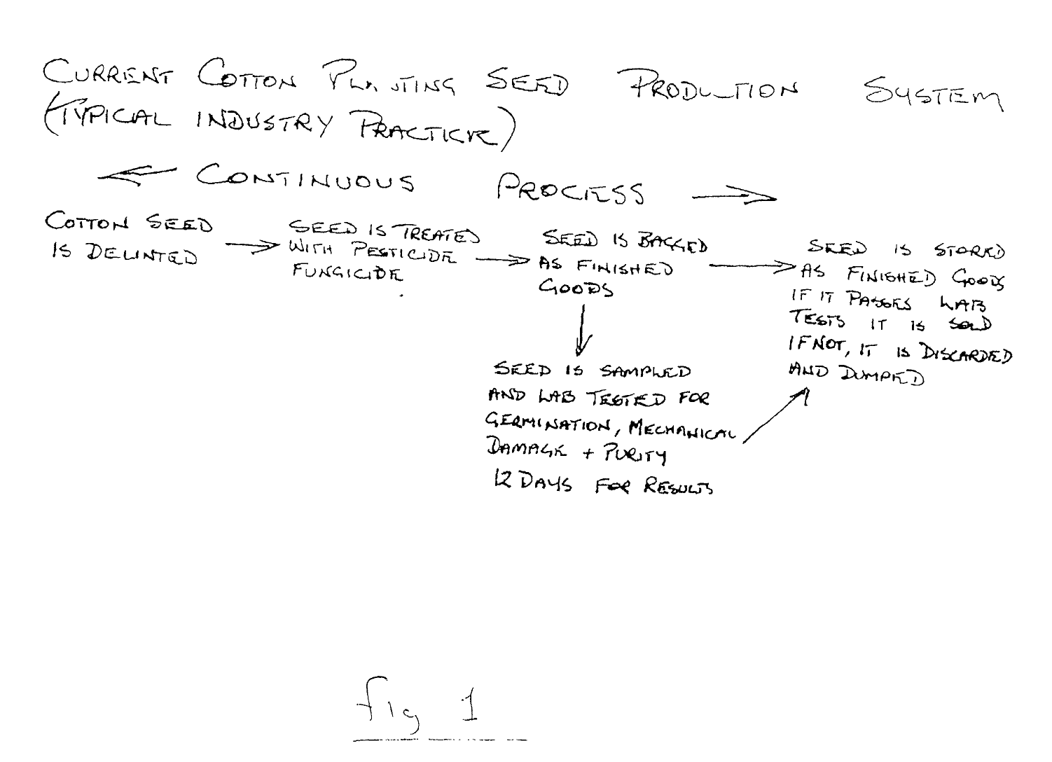

As earlier described in the specification and with reference to FIG. 1 a prior art arrangement particularly suited for processing raw cotton seed into a state where it is suitable for planting for cultivating cotton crops comprises the following steps:

1. The raw cotton seed is delinted;

2. The seed is then treated with a pesticide and/or a fungicide thereby to render the seed more suitable for use to cultivate cotton crops;

3. The chemically treated seed is bagged;

4. Prior to storing as finished goods the bagged seed is sampled and laboratory tested according to Internationally accepted standards to ensure its suitability for use. Tests include tests for germination, mechanical damage and purity;

5. That seed which passes the tests is stored as finished goods for sale. The seed which fails the test is discarded as unsuitable for commercial use. Such seeds, because of its chemical treatment, is usually only good for dumping and not for commercial use of any kind.

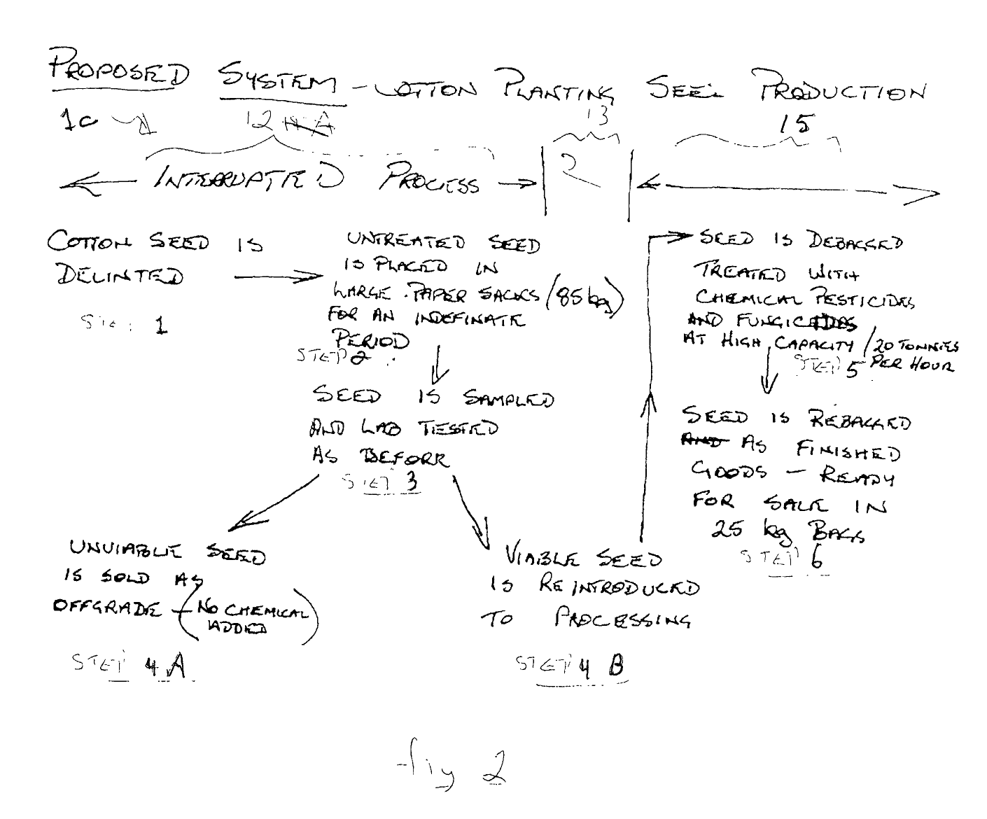

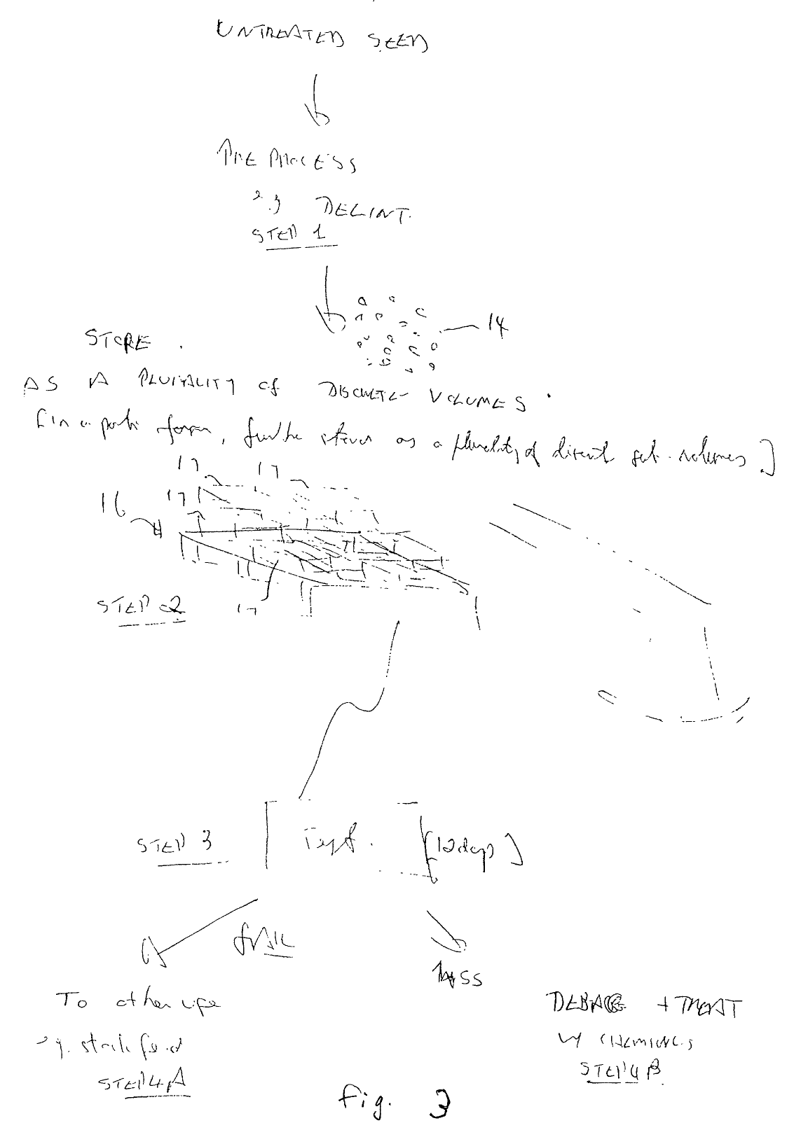

With reference to FIGS. 2 and 3 one embodiment of the present invention particularly suited to the processing of raw cotton seed for the purpose of rendering the cotton seed suitable for use as cotton planting seed (i.e. for cultivating crops of cotton) comprises, with particular reference to FIG. 2, the following steps:

Step 1: The incoming raw seed is delinted.

Step 2: The seed, after delinting and before any chemical treatment is subdivided into predetermined volumes in the form of paper sacks, each sack, in this instance, adapted to hold 85 kgs of seed. Each paper sack of predetermined volume is placed on a pallet up to pallet capacity. The palletised paper sacks are then stored for what can be an indefinite period.

A typical predetermined period of time for storage during this step can be anywhere from 12 days through to three years or so. A typical predetermined period of time is more often likely to lie in the range 12 days to one year and, more particularly, an average predetermined period will be of the order of four months.

Step 3: the stored, untreated seed is sampled and tested for specified qualities and according to International Standards thereby to determine whether the seed is of a nature suitable for commercial use as cotton planting seed.

The testing procedure is to ISTA standards and, in this particular embodiment, each 85 kg bag of seed on any given pallet is speared with sampling equipment. The small samples taken from each bag are grouped as representative of the entire contents of the pallet and a decision is made on the basis of this group sample as to whether to accept the pallet load in its entirety or reject it—see steps 4A, 4B.

Step 4A: That seed which, according to tests of its samples, is not suitable for commercial use as cotton planting seed is segregated for use other than as cotton planting seed.

Step 4B: That seed which is determined as suitable for commercial use as cotton planting seed is selected for processing as finished goods suitable for use as cotton planting seed.

Step 5: That seed which has been selected in Step 4B is debagged from the paper sacks, treated with chemicals to improve suitability of the seed for use as cotton planting seed. The chemical treatment can include the application of pesticides and/or fungicides and/or coatings. This step can be carried out at a processing rate many multiples of the processing rate applied to the pre-processing of the cotton seed prior to storage in predetermined volumes according to step 2. In one particular form the processing rate for application of chemicals can be of the order of 20 tonnes of seed per hour.

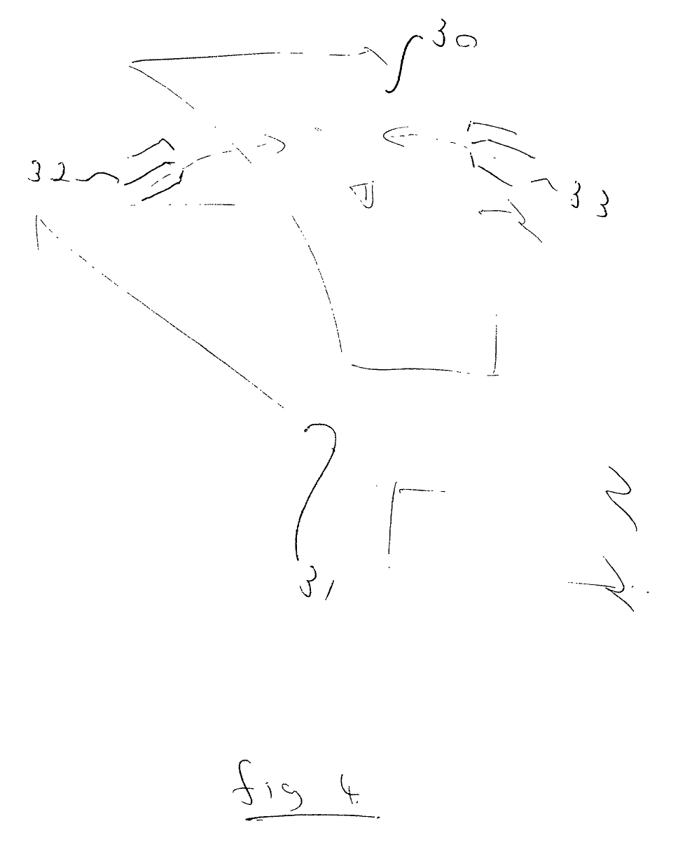

Preferred insecticides or pesticides include Gaucho 600 Flowable Seed Dressing Insecticide marketed by Bayer under product descriptor Gaucho 600 FS 175L which includes the active ingredient Imidacloprid. A suitable fungicide is Apron XL 350 ES Fungicide Seed Treatment which includes the active ingredient Metalaxyl-M. Other chemical treatment which can be used in alternative preferred forms in this step includes Cruiser 350 FS Insecticide Seed Treatment containing active ingredient Thiamethoxam; Peridiam Blue Seed or Yellow Seed Coating marketing by Rhone-Poulenc; Semevin Super Seed Dressing Insecticide marketed by Aventis CropScience Pty Ltd; Quintozene Seed Dressing Fungicide marketed by Rhone-Poulenc. A suitable spray nozzle arrangement is illustrated in FIG. 4 for application of the chemical treatment of pesticides and/or fungicides.

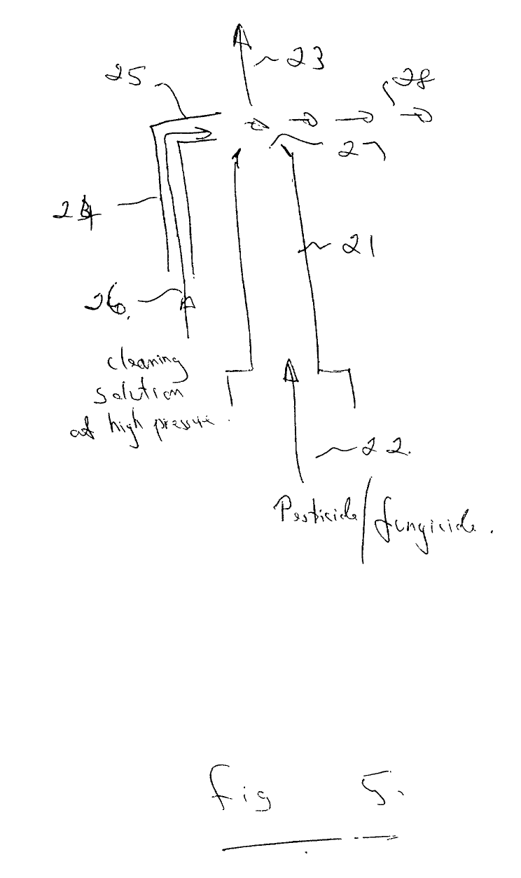

In this embodiment the seed for treatment is formed into a moving curtain 30 falling into trough 31 and having a first spray nozzle 32 and a second spray nozzle 33 spraying the chemical substance comprising the chemical treatment from opposed directions onto and into the curtain 30 of falling seeds. The nozzles 32, 33 incorporate a cross-flow cleaning system as will be described in more detail with reference to FIG. 5.

Specifically a main spray nozzle 21 is adapted to deliver a spray of pesticide/fungicide 22 in a substantially first direction 23. A secondary cleaning nozzle 24 includes a cross-delivery nozzle 25 adapted to deliver a cleaning solution 26 at high pressure across (which is to say substantially at 90°) to direction 23 across primary nozzle orifice 27 thereby to deliver stream 28 of cleaning solution so as to clean away or dislodge any pesticide/fungicide which has collected at or about orifice 27. In a particular form the cleaning solution 26 is sprayed intermittently across orifice 27 at a frequency and duration which, in addition to performing the dislodging function also tends to prevent the pesticide/fungicide from drying out at or near orifice 27 thereby to prevent blockages of orifice 27 from occurring in the first place. This cleaning arrangement obviates the need for cleaning of orifice 27 by hand and thereby reducing exposure of workers to the pesticide/fungicide 22.

It is noted that the chemical Peridiam is a particular cause of nozzle blockages and in respect of which the above cross-flow cleaning arrangement is particularly advantageous.

A preferred frequency and duration of operation of the cleaning nozzles 25 is for a period of between 0.75 and 1.5 seconds approximately every 10 minutes of operation of the main nozzle 21 (refer FIG. 5) if the cleaning solution 26 is projected under a pressure of 1000 psi or thereabouts and is appropriately angled with respect to the main nozzle 21 it is possible to effectively stop the flow of chemical treatment during the period of cleaning.

A particularly preferred cleaning solution is water or water mixed with a mild detergent.

Step 6: The seed, after chemical treatment according to step 5, is rebagged in volumes suited to commercial sale, in this instance bags of 25 kg capacity or in a particular preferred form 20 kg capacity, thereby completing the process of treated seed production according to a preferred embodiment of the invention.

With particular reference to FIG. 3 the process above described with reference to FIG. 2 will be further described and in further detail:

The treated seed production system 10 as described with reference to FIG. 2 can be thought of as a batch process or an interrupted process and comprising pre-processing incoming cotton seed 11 according to pre-testing steps 12 rendering the seed suitable for storage for indeterminate storage period 13. During indeterminate storage period 13 selected portions of pre-processed seed 14 are tested in accordance with step 3 and that seed which passes the testing step of step 3 is made available in post testing steps 15 comprising steps 5 and 6.

In this instance, with particular reference to FIG. 3, step 2 comprises storing the seed which has passed through the pre-testing steps in predetermined volumes in the form of a pallet load 16 of seed comprising, more specifically, a predetermined volume of seed segregated into discrete sub volumes in the form of bags 17 of seed. In one particular form the bags comprise large paper bags of 85 kg capacity, the paper from which each bag 17 is comprised being plain, unbleached paper suitable for recycling.

Step 3 comprising testing can take up to 12 days and comprises taking samples from each bag 17 comprising pallet load 16 and processing the samples according to accepted methods suited to determine whether the seeds are suited to cotton planting seed use.

Those pallet loads 16 whose samples past the test of step 4B are passed to post-testing steps 15 comprising step 5 and step 6 as previously described.

Those pallet loads 16 which fail the test of step 3, because, to this point, they have not been contaminated with any chemicals in accordance with step 5, can be made available for other commercial use such as, for example, stock feed, in accordance with Step 4A.

The above described arrangement according to the first preferred embodiment illustrated with respect to FIGS. 2 and 3 provides a process particularly suited to the production of planting seed and, more particularly cotton planting seed and which process provides the separation of the treatment process into a pre-testing step or phase which can proceed at a relatively slow rate of production over an extended period of time followed by a post-testing step or phase which is in the form of a “just in time” phase which can be applied to only those volumes of seed which are immediately required for a specified commercial use and in respect of which the chemical processing step of step 5 can be tailored according to the envisaged or intended immediate commercial use of just that volume.

The above describes only one embodiment of the present invention and modifications, obvious to those skilled in the art, can be made thereto without departing from the scope and spirit of the present invention.

1. A method of producing treated seed for cotton planting comprising the steps of, in order:
i. Delinting the seed;
ii. Storing the seed in bags for a predetermined period of time;
iii. Testing a predetermined portion of the seed for suitability for planting;
iv. Only that seed which is tested as suitable for planting is treated with chemicals which render the seed more suitable for planting.

2. The method of claim 1 wherein that seed which is discarded as unsuitable is made available for other commercial use.

3. The method of claim 2 wherein said other commercial use is stock feed.

4. The method of claim 1 wherein treatment of seed with chemicals is carried out at a rate higher than the rate at which seed is delinted.

5. A method of intermediate storage of a predetermined quantity of seed comprising storing said predetermined quantity as a plurality of discrete volumes of seed.

6. The method of claim 5 wherein said discrete volume comprises a pallet load of seed.

7. The method of claim 5 wherein said discrete volumes are further subdivided as a plurality of discrete sub-volumes.

8. The method of claim 7 wherein said discrete sub-volume comprises a bag of seeds.

9. The method of claim 8 wherein said bag is comprised of a paper-based material.

10. A method of intermediate storage of a quantity of seeds comprising placing said seeds in bags for storage for a predetermined period of time prior to the application of a chemical treatment process to said seeds.

11. The method of claim 10 wherein said chemical treatment process comprises coating said seeds with a chemical.

12. The method of claim 10 wherein said chemical treatment process comprises application of a chemical pesticide to said seed.

13. The method of claim 10 wherein said chemical process comprises the application of a fungicide to said seeds.

14. The method of claim 12 where an application of said chemical pesticide or said fungicide is performed by means of spray delivery through a nozzle; said nozzle incorporating self-cleaning means.

15. The method of claim 14 wherein said self-cleaning means comprises a nozzle adapted to deliver a spray of cleaning solution substantially across an orifice of said nozzle.

16. The method of claim 15 wherein said nozzle delivers said cleaning solution substantially at right-angles to the direction at which pesticide/fungicide exits from said orifice.

17. The method of claim 16 wherein said cleaning solution is caused to spray intermittently across said orifice.

18. The method of claim 10 wherein said chemical treatment process processes 20 tonnes or more of seeds per hour.

19. A method of preparing seeds for use as cotton planting seed, said method comprising a first pre-testing phase which includes storage of seeds for an indeterminent period in bags followed, after testing, by a post-testing phase which comprises applying a chemical treatment to that seed which has passed said test thereby rendering that portion of said seed which has passed said test more suited for use as cotton planting seed.

20. The method of claim 19 where an application of said chemical pesticide or said fungicide is performed by means of spray delivery through a nozzle; said nozzle incorporating self-cleaning means.

21. The method of claim 19 wherein said self-cleaning means comprises a nozzle adapted to deliver a spray of cleaning solution substantially across an orifice of said nozzle.

22. The method of claim 20 wherein said nozzle delivers said cleaning solution substantially at right-angles to the direction at which pesticide/fungicide exits from said orifice.

23. The method of claim 21 wherein said cleaning solution is caused to spray intermittently across said orifice.

24. An apparatus for the production of cotton planting seed operating according to the method of claim 19.

25. A treated seed production system, said system operating according to the method of claim 1.

26. A spray nozzle for a pesticide or fungicide; said nozzle incorporating an orifice adapted to deliver said pesticide or said fungicide in a first exit direction; a cleaning nozzle mounted in a predetermined relationship to said orifice whereby cleaning solution is delivered by said cleaning nozzle in a direction substantially at right-angles to said first exit direction, thereby to clean said orifice.

27. The nozzle of claim 26 wherein said cleaning solution is delivered by said cleaning nozzle as an intermittent spray.

28. The method of claim 1 wherein said predetermined period of time is in the range 12 days to 3 years.

29. The method of claim 1 wherein said predetermined period of time is in the range 12 days to 1 year.

30. The method of claim 1 wherein said predetermined period of time is of the order of 4 months.

31. The method of claim 1 wherein said predetermined portion comprises a mixture of samples, one from each of said bags.
